(19) United States
(12) Patent Application Publication
(10) Pub. No.: US 2004/0145473 A1
(43) Pub. Date: Jul. 29, 2004

(54) Security device for jewelry

(76) Inventor: George R. Royer, Toledo, OH (US)

Correspondence Address: GEORGE R. ROYER, 2137 RAGAN WOODS DR, TOLEDO, OH, 43614, US

(21) Appl. No.: 10/351,093

(22) Filed: Jan. 27, 2003

(51) Int. Cl. G08B 13/12

(52) U.S. Cl. 340/568.2; 340/568.8

(57) ABSTRACT

The subject invention is centered on an improved device for security and holding jewelry in a store setting so that the risk of theft is minimized while the jewelry is being shown or demonstrated for potential sales, such device comprising a flexible cord like or wire member having means on the upper end to hold a jewelry item secured to the cord like member while the lower end of the cord-like member is secured to a fixed item or a security alarm so that the jewelry item is secured from unauthorized removal.

### DISCUSSION OF PRIOR ART AND BACKGROUND OF INVENTION

This application is directed to items that are used to help secure valuable in a store or other environments so that they cannot be easily removed without authorization. There are few and ineffective devices to store settings, with means to maintain the jewelry item in a secured position while being held and observed by a prospective buyer.

It is an unfortunate aspect of present society that frequent attempts are made to steal or rob items from many sources, commercial or otherwise. One of the most frequent targets of thefts are jewelry stores. Quite often these jewelry store robberies occur when an individual enters a jewelry store and ask to see a particular jewelry item. In these circumstances the jewelry store employee retrieves a jewelry item such as a ring and gives it to the customer to hold and observe and possibly stay on for signing. The prospective customer thus has the ring in his or her hand and pay place the ring on their finger. In many circumstances where the customer has the ring he or she may suddenly exit the store and run away with the ring, all within short space of time before alarms can be activated or guards can be called to the scene.

It should be noted that other applications can be used in this regard, other than preventing jewely thefts. Accordingly the following objects are directed accordingly.

### OBJECTS OF INVENTION

The following are objects of the subject invention.

It is object of the subject apparatus to provide an improved security device for protecting theft items from their given locations.

It is also an object of the subject invention is to provide a means to protect an item of value from theft.

An additional object of the subject invention is to provide improved means to secure jewelry from theft in a jewelry store.

A further object of subject invention is to provide an improved structure for holding a jewelry item in a secure position while being examined or fitted for potential 11 sale.

Yet another object of the subject invention is to provide an improved structure to hold a jewelry item time during as a prospective sales in session.

A further object of the subject invention is to provide an improved structure to hold a jewelry piece from being taken away before sale.

Still another object of the subject invention is to provide means to secure a personal property item in a secure position.

Other and further objects of the subject invention can be seen in the following description and claims read in view of the drawings herein.

### IN THE DRAWINGS

FIG. 1. Is a front view of the subject invention, shown in section.

FIG. 2. Is a front elevation view of the subject invention, shown in section with an alarm.

### DESCRIPTION OF GENERAL EMBODIMENT AND SUMMARY OF INVENTION

The subject invention is centered on an improved device for security and holding jewelry in a store setting so that the risk of theft is minimized while the jewelry is being shown or demonstrated for potential sales, such device comprising a flexible cord like or wire like member having means on the upper end to hold a jewelry item secured to the cord like member while the lower end of the cord-like member is secured to a fixed item or a security alarm so that the jewelry item is secured from unauthorized removal or affixed so that removal would set off an alarm

In general, the subject invention is a longitudinally extending cord member having a first end, which is alternatively referred to as the upper end and a second end, which is also referred to as the lower end. The upper end of the cord member may be equipped with a loop member or other means which is either detachable or fixed, such loop or other means having structural attributes to permit an attachment of a jewelry item such as a ring, or other valuable items.

In the most basic embodiment of the subject invention it incorporates a longitudinally extending cord member that has a loop member on the upper end to which the item of personal property can be attached for temporary observation purposes. A security apparatus may be annexed to or integrated with the portion of the cord so that the cord member cannot be pulled away with the jewelry item attached. Another embodiment, as stated, could include alarm means connected directly or in direct with said cord member, so that when an individual tries to pull the cord or take the items on the cord it will set off an alarm immediately.

### Description of Prepared Embodiment of Subject Invention

It is to be stressed that a preferred embodiment of the subject invention is set forth below and such description of a preferred embodiment is not to be construed as limiting the scope of the subject invention to such description as set forth in the annexed claims. Thus, the fact that one embodiment is described in the following description does not preclude the inclusion of other embodiments within the scope of the claims. Moreover, while the subject invention is focused and centered on a table member or a base counter member the invention can be structured and deployed other than on a table or base counter member so long as means exist to support such security apparatus. Moreover, it is to understood that the subject invention is not solely limited to a jewelry security apparatus as described below.

Attention is addressed to the drawings in which a preferred embodiment of the subject invention as shown. A base jewelry display counter 10 is shown as being supported on an upright base member 25, such base member being adapted to be placed on a floor or on the ground, or on any other appropriate surface. The invention may contemplate that the base member may merely rest on the ground or floor on its lower surface or be suspended upright or otherwise supported.

As stated, it is to be noted that the fact that the invention describe herein is adapted to be annexed to a jewelry display counter shall not be considered as a limitation on the scope of the subject invention, as the subject invention may be affixed to some other object or portion of real or personal property for the security purposes set forth herein.

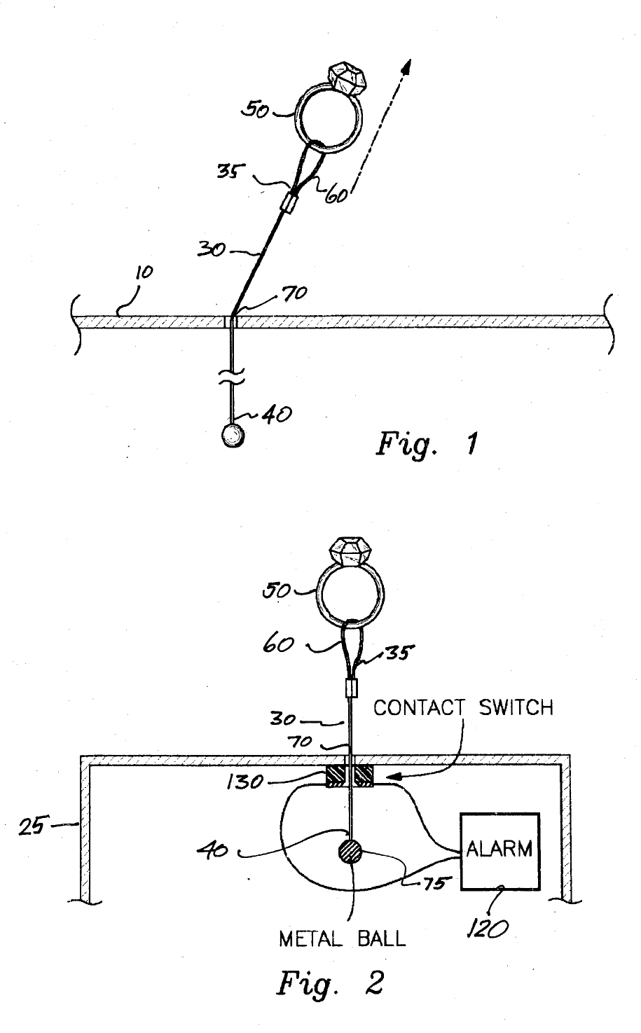

Attention is directed to the embodiment shown in FIGS. 1 and 2, of the drawings and as graphically shown in such drawings is a longitudinally extending cord member 30 having a first upper end 35 and a second or lower end 40. The cord member 30 is preferably comprised of a strong tensile resistant material that makes it difficult to pull the cord apart or sever it quickly as the concept encompasses and contemplates that the cord will be strong enough to resist forcible pulling away or severance of the cord member by a potential thief. The cord member may be a wire member or otherwise.

As can be seen the cord member 30 has on its upper end 35 some means to hold a jewelry item to the upper end on upper or other portion of the cord member 30. Since the drawings reflect a ring 50 being held, the preferred embodiment will hereinafter be described in terms of application to a jewelry ring. However it is to be understood that the subject invention as described in this application shall not be limited to a ring jewelry item as it has application to other jewelry items or other types of personal property. More specifically, the upper end of the cord member 30 has a loop member 60 integrally attached at or near the upper end 35 of the cord member 30 with this loop member being detachable or otherwise integral with the cord 30 strand. It is preferably however, that the loop member 60 have means therein to open and close such loop, either with attached locking means, not shown to lock or unlock the loop. Such locking means would preferably be under the exclusive control of the jewelry salesman or other appropriate personal.

The lower end 40 of the cord member 30 is adapted to be affixed to the base member of the counter 10 or base member 25, and for this purpose the cord member 30 may be permanently affixed to the counter and or near the lower end 40 of the cord member 30. More specifically, the first or lower end 40 of cord member 30 may be affixed permanently into the counter 10 so that the cord member 30 is securely fixed at all times to some base structure. In the embodiment shown in FIG. 1, the lower end 40 of the cord member 30 is inserted through a narrow opening 70 in the counter 10 with a relatively enlarged ball 75 or other object of a diameter greater than that of the opening. This will prevent the cord 30 from being pulled away from the counter 10. Other means may be used to hold the cord 30 fixed to the counter 10 or base member 25 affixed on the end of the cord.

The cord member 30 or at least the strands forming the loop member 60 should be of minimal or optional diameter so that a ring can be placed on the loop member and still permit the ring to be worn on a finger without interference of the cord with this fitting process. This latter aspect would be less critical for other jewely items. It is important to stress in this regard that the strand forming the loop should be of sufficient strength, from a tensible strength perspective to hold while withstanding intensive pulling pressure. In this preferred embodiment with the lower end of the cord being attached to the base member 25, the ring is slipped onto the loop member 60 of the cord member 30 and the ring can then be placed at any position on the loop member 60 and be potentially held and or worn for observation purposes, while on such loop member. Just immediately after fitting the ring as stated the loop is opened preferably in the customers absence and the ring placed back in the counter.

In general, the subject device may be structured other than as a cord member locked to a counter or base, so long as the device has some means to secure the item relative to a fixed object so that it cannot be pulled away and stolen, through stealth or force or otherwise, and so long as the system or apparatus permits a prospective customer to observe the item. For this purpose the loop member may be already attached to the ring or attached and thus may be attached to the cord as necessary by means other than as described above. For example, the embodiment shown in FIG. 2, lower end 40 of the cord member is indirectly connected to an alarm member 120 which is activated when the cord 30 is pulled upwardly to a contact switch 130 at the opening through which the cord end is inserted, such activation of the alarm occurring when the ball at the end of the alarm is pulled upwardly and contacts the contact switch 120.

In summary the subject invention is a device for indirectly securing an item of jewelry to a fixed object in a store during the process of observing the jewelry in comprising;

a. a fixed counter member in store;

b. securing means on the counter member;

c. a longitudinally extending cord member such cord member having a first end and a second end, with the second end being secured in the securing means in the counter member;

d. jewelry holder means on the first end such loop means adapted to hold an item of jewelry;

In further summary the subject invention is a device for securing an item of jewelry for and during the process of observing the jewelry comprising;

a. a fixed base member;

b. securing means on said base member;

c. a longitudinally extending cord member, such cord member having a first end portion and a second end portion with such second end portion being secured in part to said securing means on said base member;

d. jewelry holding means on said first end portion of such cord member adapted to hold an item of jewelry;

In further summary the subject invention is a device for securely holding items of jewelry during the process of having one hold and observed the jewelry items for a potential purchase o said jewelry, item, comprising;

a. a base member;

b. longitudinally extending member having a first and second end, with part of said second portion of said longitudinally extending member being attached to the said fixed member;

c. attachment member affixed on the first portion of said longitudinally extending member, said attached means being adapted to hold an item thereon;

1. A device for indirectly securing an item of jewelry to a fixed object in a store during the process of observing the jewelry comprising;
a. a fixed member in store;
b. securing means on said fixed member;
c. a longitudinally extending flexible member said flexible member having a first end and a second end, with the second end being secured in said securing means on said fixed member;
d. holding means on the first end said flexible member adapted to hold an item of jewelry;

2. A device for securing an item for and during the process of observing the item comprising;
a. a fixed base member;
b. securing means on said base member;
c. a longitudinally extending flexible member, said flexible member having a first end portion and a second end portion with said second end portion being secured in part to said securing means on said base member;
d. item holding means on said first end portion of said flexible member adapted to hold an item of jewelry;

3. A device for securely holding an item of jewelry during the process of having one hold and observed said jewelry item for a potential purchase said jewelry, item, comprising;
a. a base member;
b. longitudinally extending flexible member having a first and second end, with part of said second portion of said longitudinally extending member flexible member being attached to the said base member;
c. attachment member affixed on the first portion of said longitudinally flexible extending member, said attachment member being adapted to hold an item of jewelry thereon;
